(19) United States
(12) Patent Application Publication
(10) Pub. No.: US 2005/0220131 A1
(43) Pub. Date: Oct. 6, 2005

(54) Method and apparatus to multicast transmission

(76) Inventors: Boris Ginzburg, Haifa (IL); Adrian Stephens, Cottenham (GB)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/813,027

(22) Filed: Mar. 31, 2004

(51) Int. Cl. H04J 1/00

(52) U.S. Cl. 370/432; 370/480

(57) ABSTRACT

Briefly, a method and apparatus to acknowledge multicast transmission by a station. The station may transmit acknowledgement signal over a dedicated frequency sub-channel which may be allocated by an access point.

### BACKGROUND OF THE INVENTION

In wired and/or wireless local area networks (e.g. LAN and WLAN, respectively) an access point (AP) may utilize multicast transmissions. Multicast transmissions may be used, for example, to broadcast data that include multimedia content from the AP to one or more stations over a channel.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by referring to the following detailed description when read with the accompanied drawings in which:

FIG. 1 is a schematic illustration of a wireless communication system according to an exemplary embodiment of the present invention;

FIG. 2 is a schematic illustration of an exemplary timing diagram of transmissions within a wireless communication system channel according to an exemplary embodiment of the present invention;

FIG. 3 is a schematic illustration of an exemplary processor according to embodiments of the present invention;

FIG. 4 is a block diagram of an exemplary access point according to embodiments of the invention; and

FIG. 5 is a block diagram of an exemplary mobile communication device according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating”, “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, stations for receiving and transmitting spread spectrum signals such as, for example, Frequency Hopping Spread Spectrum (FHSS), Direct Sequence Spread Spectrum (DSSS), Orthogonal frequency-division multiplexing (OFDM) and the like.

Some embodiments of the invention may be implemented, for example, using a machine-readable medium or article which may store an instruction or a set of instructions that, if executed by a machine (for example, by a station, and/or an access point and/or by other suitable machines), cause the machine to perform a method and/or operations in accordance with embodiments of the invention. Such machines intended to be in the scope of the present invention include, although are not limited to, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, high level design programming language, assembly language, machine code, or the like, although the scope of the present invention is not limited in this respect.

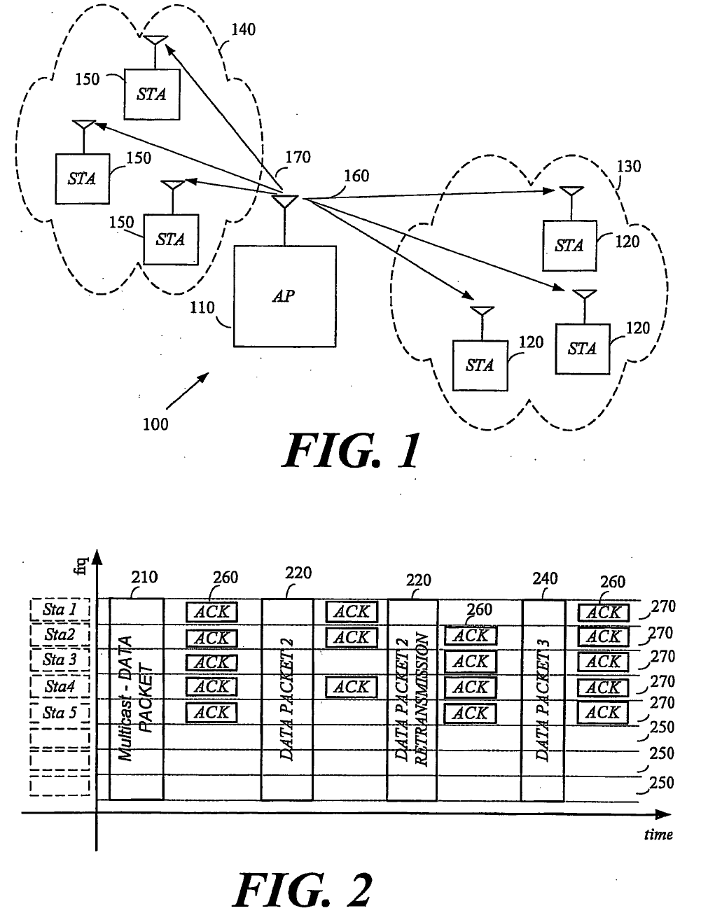

Turning first to FIG. 1, a wireless communication system 100, for example, a WLAN communication system is shown. Although the scope of the present invention is not limited in this respect, the exemplary WLAN communication system 100 may be defined by IEEE 802.11-1999 standard, as a basic service set (BSS). For example, the BSS may include at least one AP 110 and at least one station (STA) 120. However, in this exemplary embodiment, wireless communication system 100 may include at least two groups of stations 130, 140 that may receive from AP 110 multicast transmissions over channels 160, 170, respectively. A channel may be referred to by one skilled in the art as a shared wireless media, if desired.

Although the scope of the present invention is not limited in this respect, group 130 may include stations 120 and group 140 may include stations 150. It should be understood that the number of the stations in the groups is not limited to a particular number of stations. Groups 130 and 140, for example, may include a subset of stations, wherein the number of stations of the subset of stations may include any desired number of stations. In some embodiments of the invention, the subset of stations may include all the stations of the group. Additionally and/or alternatively, the stations may be grouped according to some predetermined criterions such as, for example, a dynamic range of a station receiver. In embodiments of the invention, AP 110 may group the stations according to their signal strength. For example, stations having one predetermined range of signal strength values may be group in one group and stations having a second predetermined range of signal strength values may be grouped in another group.

Although the scope of the present invention is not limited in this respect, AP 110 may use various methods to group the stations, for example, in some embodiments of the invention, AP 110 may group the stations according to their distance from AP 110, if desired. In some embodiments of the invention, AP 110 may group the stations according to a desired application that may be multicast transmitted to the stations. In some embodiments of the inventions the stations may be members in two or more groups, for example, AP 110 may allocate two or more multicast addresses to a stations In some embodiments of the invention, AP 110 may allocate a station to one or more groups that may receive substantially similar content, according to the signal strength that received from the station, if desired. AP 110 may send the station a multicast address that identifies its group, and the station may listen for that address, if desired. It should be understood that in embodiments of the invention AP 110 may group the station according to any desired criterion and the scope of the present invention is in no way limited in this respect.

Turning to FIG. 2, a schematic illusion of an exemplary timing diagram of transmissions within a wireless communication system channel 200 according to an exemplary embodiment of the present invention is shown. Although the scope of the present invention is not limited in this respect, a frequency bandwidth of channel 200 may be divided into frequency sub-channels 250, 270 for example eight sub-channels. In some embodiments of the invention, the number of sub-channels may be varied according to a frequency offset and a required frequency separation between the sub-channels. For example, 5 Giga Hertz (GHz) channel may have a carrier offset of 0.25 Mega Hertz (MIz). Thus, the sub-channel width may be a predetermined time of the carrier offset.

Additionally and/or alternatively, channel 200 may include a fixed number of OFDM sub-carriers, if desired. In some embodiments of the invention, the number of sub-channels may be substantially equal or higher then the number of stations in a group of stations (e.g. group 130) that may receive a multicast transmission of a data packet 210. For example, a group may include five stations (e.g. station 1, station 2, station 3, station 4, station 5) and channel 200 may be divided into eight sub-channels 250, 270, if desired.

Additionally or alternatively, a subset of sub-channels for example sub-channel 250 may be dedicated to a subset of stations for example, station 1, station 2, station 3, station 4, station 5, if desired. In some embodiments of the invention, the number of sub-channels may be lower than the number of stations in the group. In this case, a sub channel may be allocated to more than one station in the group having different multicast address from station to station. In some embodiments, of the invention a sub-channel may be allocated to stations from different groups, if desired.

Although the scope of the present invention is not limited in this respect, an exemplary scenario of multicast transmission to a group of stations (e.g. station 1, station 2, station 3, station 4, station 5) is shown. The stations may acknowledge reception of the multicast transmission of data packed 210 over the dedicated sub-channels 270. For example, data packet 210 may be successfully received by subset of stations (e.g. station 1, station 2, station 3, station 4, and station 5). Thus, the stations may send an acknowledge signal 260 on their dedicated subset of sub-channels 270 to a transmitting station (not shown), for example, an AP. In response, the transmitting station may multicast transmitted data packet 220 that may be received and acknowledged by at least some of the stations for example, station 1, station 2 and station 4. In this example, the transmitting station may retransmit data packet 220 until all the stations of the group acknowledged at least once, the reception of the multicast transmission of data packet 220, although the scope of the present invention is in no way limited in this respect.

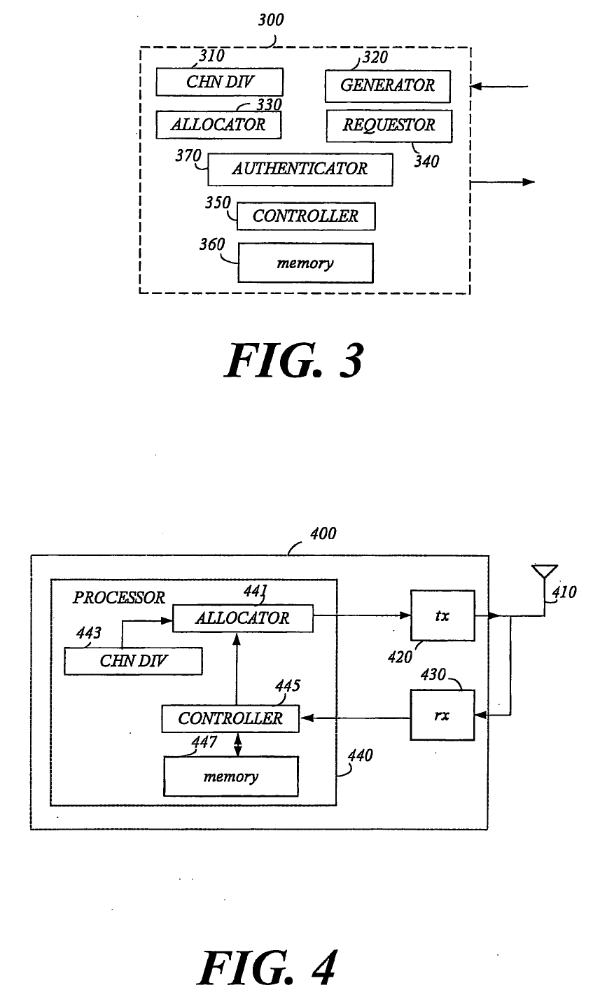

Turning to FIG. 3 a schematic illustration of an exemplary processor 300 according to embodiments of the present invention is shown. Although the scope of the present invention is not limited in this respect, processor 300 may include for example, a channel divider (CHN DIV) 310, an allocator 330, a generator 320, a requestor 340, a controller 350 and a memory 360.

Although the scope of the invention is not limited in this respect, processor 300 may be a media access control (MAC) processor, a digital signal processor, a baseband processor and the like. In embodiments of the invention, processor 300 may be embedded in a mobile station, an AP, or in any other wireless communication device, if desired.

In embodiments of the invention, channel divider 310 may divide a frequency bandwidth of a channel (e.g. channel 200) into frequency sub channels (e.g. sub-channel 270) wherein the number of the frequency sub-channels may be dependent on a desired frequency bandwidth of the sub-channel and separation between the sub-channels. Allocator 330 may allocate a subset of sub-channels, e.g. sub-channels 270, to the stations in the group for acknowledging reception of the data packet. Controller 350 may control multicast transmission of data packets. For example, controller 350 may control a transmitter, for example a transmitter of an AP, to perform a multicast transmission of a data packet to the group of stations after receiving acknowledgement signals from a desired number of stations of the group.

Although the scope of the present invention is not limited in this respect, in order to control the multicast transmissions, controller 350 may receive a group membership request from at least subset of stations of the group which may include one or more stations and may send a membership acceptance message to the subset of stations of the group. In some embodiments of the invention, processor 300 may include an authenticator 370 that may authenticate at least a subset of the stations of the group before sending the membership acceptance to a requesting station. In some embodiments of the invention, processor 300 may be embedded in the requesting station and may include a requestor 340 which may request a group membership from a multicast receiving station. In this example, a memory 360 may store a membership token, received from the multicast transmitting station, although the scope of the present invention is in no way limited in this respect.

Although the scope of the present invention is not limited in this respect, generator 320 may generate an acknowledgement signal. In some embodiments of the invention, generator 320 may generate a burst signal for a predetermined time which may distort the sub-channel, if desired. In other embodiments of the invention, generator 320 may generate an acknowledgement frame, for example, an acknowledgement frame defined by IEEE 802.11-1999 or the like.

Although the scope of the present invention is not limited in this respect, the acknowledgement signal may convey a single bit of information in the allocated sub-channel to indicate that the previous frame and/or data packet may be received. For example, the acknowledgement signal may be an unmodulated and/or modulated carrier. Alternatively, generator 320 may generate an acknowledgement signal that may be a defined pattern that may be detected using its known cross-correlation (with the expected pattern) and/or auto-correlation properties regardless of carrier and timing offset.

Although the scope of the present invention is not limited in this request, channel divider 310, generator 320, allocator 330, requestor 340, authenticator 370 and controller 350 may be implemented in software, in hardware and/or in any suitable combination of software and hardware.

Turning to FIG. 4, a block diagram of an exemplary access point (AP) 400 according to embodiments of the invention is shown Although the scope of the present invention is not limited in this respect, AP 400 may include an antenna 410, a transmitter (TX) 420, a receiver (RX) 430 and processor 440.

Although the scope of the present invention is not limited in this respect, antenna 410 may be used to multicast transmit data packets that may be provided by TX 420 and/or to receive acknowledgement signals that may be provided to RX 430. Although the scope of the present invention is not limited in this respect, antenna 410 may include an internal antenna, or an omni-directional antenna, or a monopole antenna, or a dipole antenna, or an end fed antenna or a circularly polarized antenna, or a micro-strip antenna, or a diversity antenna, a dual antenna, an antenna array or the like.

Although the scope of the present invention is not limited in this respect, in some embodiments of the invention, TX 420 may include a power amplifier (not shown), or an outphasing transmitter with reactive termination (not shown), or a linear transmitter (not shown), or a non-linear transmitter (not shown), or the like. In some embodiments of the invention, RX 430 may include a demodulator (not shown), a baseband processor (not shown), and the like. Additionally and/or alternatively RX 430 may include two or more receiver circuits that may receive, in parallel, acknowledgement signals from two or more stations. In embodiments of the invention, the acknowledgement signal may include modulated or unmodulated carrier, a predefined pattern a message, or the like.

Although the scope of the present invention is not limited in this respect, processor 440 may include an allocator 441 a channel divider 443 a controller 445 and a memory 447, if desired. In some embodiments of the invention memory 447 may be externally connected to processor 440 and may include a Flash memory, and/or a random access memory (RAM) and/or a non-volatile memory and/or a volatile memory or the like.

Although the scope of the present invention is not limited in this respect, channel divider 443 may divide a frequency bandwidth of a channel (e.g. channel 200) into frequency sub-channels (e.g. sub channels 250 of FIG. 2). Allocator 441 may allocate the frequency sub-channels to the stations in the group for acknowledging reception of the data packet For example, allocator 441 may allocate a first sub-channel 270 to station 1, second sub-channel 270 to station 2, third sub channel 270 to station 3, etc. In some embodiments of the invention, allocator 441 may allocate sub-channel (e.g. sub-channel 270) to station based on received acknowledgment signal strength. For example, allocator 441 may measure the signal strength of the received acknowledgement signal or other management frame exchange with the station and may allocate a sub channel to the station based on the signal strength, if desired.

Although the scope of the present invention is not limited in this respect, IX 420 may transmit the allocation to the stations. In some embodiments of the invention IX 420 may transmit multicast transmissions using a channel access mechanism for example, a Carrier Sense Multiple Access with Collision Avoidance (CSMA/CA) and, more specifically, CSMA/CA with a binary exponential backoff method, if desired. For example, TX 420 may perform a first multicast transmission of a first data packet to the group of stations. RX 430 may receive acknowledgement signal from at least a subset of stations in the group and TX 420 may perform a second multicast transmission of a second data packet. In some embodiments of the invention TX 420 may perform multicast transmission of the second packet only after all the stations acknowledged reception of the multicast transmission. TX 420 may retransmit the data packet until all the stations acknowledged at least once reception of the multicast transmission, although the scope of the present invention is in no way limited in this respect.

In embodiments of the invention, controller 445 may receive a group membership request from at least a subset of the stations of a group of stations and may send membership acceptance message to the subset of stations of the group. In addition, controller 445 may authenticate at least a subset of the stations of the group, if desired. Group membership may be associated with the use of a desired multicast address assigned by the AP. For example, the AP may respond with different multicast addresses for stations that the AP wants to place in different groups on the basis of the station's received signal strength.

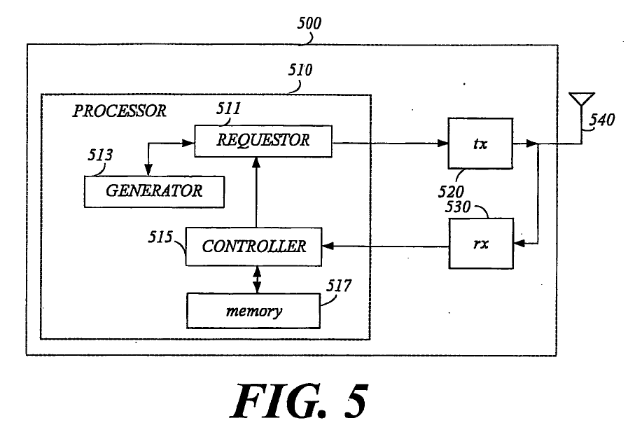

Turning to FIG. 5, a block diagram of an exemplary mobile communication device 500 according to embodiments of the invention is shown. Although the scope of the present invention is not limited in this respect, mobile station 500 may be used in a WLAN, if desired. In this exemplary embodiment of the invention, mobile communication device 500 may include a processor 510 (e.g. processor 300), TX 520, RX 530 and antenna 540. In some embodiments of the invention, processor 510 may include a requestor 511, a generator 513, a controller 515 and a memory 517.

Although the scope of the present invention is not limited in this respect, antenna 510 may be used to receive multicast transmissions of data packets and may be used to trait an acknowledgement signal. Although the scope of the present invention is not limited in this respect, antenna 540 may include an internal antenna, or an omni-directional antenna, or a monopole antenna, or a dipole antenna, or an end fed antenna or a circularly polarized antenna, or a micro-strip antenna, or a diversity antenna, a dual antenna, an antenna array or the like.

In some embodiments of the invention, TX 520 may be used to convert digital signals into baseband signals and may modulate the baseband signals to provide radio frequency signals such as OFDM signals, if desired. Furthermore, in some embodiments, TX 520 may apply different modulation schemes with different rates such as, for example, binary phase shift keying (BPSK), quadrature phase shift keying (QPSK), quadrature-amplitude modulation (QAM) with different order such as, for example, QAM16, QAM32, QAM64, QAM128, QAM256, etc., differential BPSK (DBPSK), differential QPSK (DQPSK), or the like. The different modulation schemes and the different rates may be provided according to a channel quality indication, a distance from AP and the like. RX 530 may demodulate RF signals received from antenna 540 into baseband signals and may convert the baseband signals into digital signals.

Although the scope of the present invention is not limited in this respect, generator 513 may generate an acknowledgement signal which may be transmitted by TX 520 over a dedicated frequency sub-channel (e.g. sub-channel 250 of FIG. 2). In some embodiments, generator 513 may generate a burst signal having a predetermined period which may be used as the acknowledgement signal. In some other embodiments of the invention, generator 513 may generate an acknowledgement message which may include for example, modulated or unmodulated carrier, a predetermined pattern, or the like.

In some embodiments of the invention, requestor 511 may generate a group membership request that may transmit to a multicast transmitting station (e.g. AP 400). RX 530 may receive a membership acceptance to the group from the multicast transmitting station (e.g. AP 400) and may store a membership acceptance token in memory 517, if desired.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method comprising:
dividing a frequency bandwidth of a channel into two or more frequency sub-channels to be used to transport two or more acknowledgment signals that acknowledge reception of a multicast transmission of a data packet by a group that includes two or more stations.

2. The method of claim 1, comprising:
performing a first multicast transmission of a first data packet to the group; and
performing a second multicast transmission of a second data packet after at least a subset of stations of the group acknowledged a reception of the first frame.

3. The method of claim 1, comprising:
retransmitting the data packet until an acknowledgement signal is received from a subset of stations of the group.

4. The method of claim 1 wherein allocating comprises:
receiving a group membership request from at least a subset of the stations of the group; and
sending membership acceptance to the subset of stations of the group.

5. The method of claim 1 comprising authenticating a station of the group.

6. The method of claim 1 comprising:
allocating a sub-channel of the two or more sub-channels based on a signal strength of a received acknowledgement signal.

7. The method of claim 1 comprising:
allocating a station to the group based on a received signal strength of the station.

8. The method of claim 7, comprising:
allocating a first multicast address to the station when the station is included in a first group; and
allocating a second multicast address to the station when the station is included in a second group.

9. A method comprising:
acknowledging reception of a data packet multicast transmitted over a dedicated frequency sub-channel of a wireless communication system.

10. The method of claim 9 comprising:
requesting a group membership from a multicast transmitting station; and
receiving a group membership acceptance from the multicast transmitting station.

11. The method of claim 9, wherein acknowledging comprises transmitting a burst signal to a multicast transmitting station over the dedicated frequency sub-channel for a predetermined period of time.

12. The method of claim 9, wherein acknowledging comprises transmitting an acknowledgement frame to a multicast transmitting station over the dedicated frequency sub-channel.

13. The method of claim 9, wherein acknowledging comprises transmitting a predetermined signal pattern to a multicast transmitting station over the dedicated frequency sub-channel.

14. An apparatus comprising:
a channel divider to divide a frequency bandwidth of a channel into two or more frequency sub-channels to be used to transport acknowledgment signals to acknowledged a reception of a multicast transmission by two or more stations of a group of stations; and
an allocator to allocate the two or more frequency sub-channels to the two or more stations.

15. The apparatus of claim 14, comprising:
a transmitter to perform a first multicast transmission of a first data packet to the group of stations and to perform a second multicast transmission of a second data packet after at least a subset of stations of the group acknowledged a reception of the first frame.

16. The apparatus of claim 14, wherein the transmitter performs are transmission of the flirt or the second data packet until an acknowledgement signal is received from the subset of stations.

17. The apparatus of claim 14 comprising:
a controller to receive a group membership request from at least subset of the stations of the group and to send group membership acceptance message to the subset of stations.

18. The apparatus of claim 17 wherein the controller is able to authenticate the subset of the stations of the group.

19. The apparatus of claim 14 wherein the allocator is able to allocate a sub-channel of the two or more sub-channels based on a signal strength of a received acknowledgement signal.

20. The apparatus of claim 19 wherein the acknowledgement signal comprises a predetermined pattern.

21. A mobile communication device comprising:
a generator to generate an acknowledgement signal; and
a transmitter to transmit the acknowledgement signal to respond on a reception of a data packet of a multicast transmitted over a dedicated frequency sub-channel of a wireless communication system.

22. The mobile communication device of claim 21 comprising:
a requestor to request a group membership station; and
a receiver to receive a group membership acceptance.

23. The mobile communication device of claim 21 wherein the acknowledgement signal comprises a burst signal having a predetermined period.

24. The mobile communication device of claim 21 wherein the acknowledgement signal comprises an acknowledgement message.

25. The mobile communication device of claim 21 wherein the acknowledgement signal comprises a predetermined pattern.

26. The mobile communication device of claim 21 wherein the acknowledgement signal comprises a modulated carrier.

27. The mobile communication device of claim 21 wherein the acknowledgement signal comprises an unmodulated carrier.

28. A processor comprising:
a channel divider to divide a frequency bandwidth of a channel into frequency sub-channels to be used for acknowledged a reception of multicast transmission by a group of stations; and
an allocator to allocate at least some sub-channels to a subset of stations of the group to acknowledge reception of the data packet over the at least some sub-channels.

29. The processor of claim 28, comprising:
a controller to control a transmitter to perform a first multicast transmission of a first data packet to the group of stations and to perform a second multicast transmission of a second data packet after at least the subset of stations acknowledged a reception of the first data packet.

30. The processor of claim 28 comprising:
a controller to receive a group membership request and to send a group membership acceptance message.

31. The processor, of claim 28 comprising:
an authenticator to authenticate at least the subset of the stations.

32. The processor of claim 28, comprising a generator to generate an acknowledgement signal.

33. The processor of claim 28 comprising:
a requestor to request a group membership; and
a memory to store a group membership token.

34. A mobile communication device comprising:
a dipole antenna to transmit an acknowledgement signal;
a generator to generate the acknowledgement sigal; and
a transmitter to transmit the acknowledgement signal to responded on a reception of a data packet of a multicast transmitted over a dedicated frequency sub-channel of a wireless communication system.

35. The mobile communication device of claim 34 comprising:
a requestor to request a group membership station; and
a receiver to receive a group membership acceptance.

36. The mobile communication device of claim 34 wherein the acknowledgement signal comprises a burst signal having a predetermined period.

37. A wireless communication system comprising:
two or more stations to transmit acknowledgement signal to respond on a reception of a data packet of a multicast transmitted over two or more dedicated frequency sub-channels, respectively.

38. The wireless communication system of clam 37, comprising:
an at least one access point to dividing a channel of the wireless communication into two or more dedicated frequency sub-channels.

39. The wireless communication system of clam 38, wherein the access point is able to group the two or more stations into a group and to transmit multicast transmission to the group.

40. An article comprising: a storage medium, having stored thereon instructions, that when executed, result in:
dividing a frequency bandwidth of a channel into two or more frequency sub-channels to be used to transport two or more acknowledgment signals that acknowledge reception of a multicast transmission of a data packet by a group that includes two or more stations.

41. The article of claim 40, wherein the instructions, when executed, result in:
performing a first multicast transmission of a first data packet to the group; and
performing a second multicast transmission of a second data packet after at least a subset of stations of the group acknowledged a reception of the first frame.

42. The article of claim 40, wherein the ins ons, when executed, result in:
retransmitting the data packet until an acknowledgement signal is received from a subset of stations of the group.

43. The article of claim 40, wherein the instructions, when executed, result in:
receiving a group membership request from at least subset of the stations of the group; and
sending membership acceptance to the subset of stations of the group.
